(19) United States
(12) Patent Application Publication
(10) Pub. No.: US 2007/0136128 A1
(43) Pub. Date: Jun. 14, 2007

(54) METHOD AND SYSTEM TO PROVIDE ELECTRONIC PARKING VALIDATION FOR DRIVERS USING A PAY BY CELL PARKING SYSTEM

(76) Inventors: THOMAS ANDREW JANACEK, Calgary, AB (CA); JACQUELINE DEJONG, Cochrane, AB (CA)

Correspondence Address: J C PATENTS, INC., 4 VENTURE, SUITE 250, IRVINE, CA, 92618, US

(21) Appl. No.: 11/609,490

(22) Filed: Dec. 12, 2006

Related U.S. Application Data
(60) Provisional application No. 60/749,358, filed on Dec. 12, 2005.

(51) Int. Cl. G07B 15/00

(52) U.S. Cl. 705/13

(57) ABSTRACT

A method and a system provide electronic parking validation using a pay by cell parking system is disclosed. The system allows any entity to offer instant parking credit covering a portion or the whole amount of parking charges. The credit is directly applicable to the current parking charges. The system has an operational pay-by-cell parking system in place and the recipient of the parking credit is a registered customer in good standing of the system. The system comprises a suite of computer programs residing on a server for remote wireless parking management and payment. The suite of computer programs verifies a third party payment request, such a third party using a wireless or landline telephone to request access. The suite of computer programs grants or rejects such access request based on a plurality of authentication rules defined within the server resident program suite.

### CROSS-REFERENCE TO RELATED APPLICATION

This application claims the benefit of U.S. Provisional Application No. 60/749,358 filed on Dec. 12, 2005. The entirety of the above-mentioned prior provisional application is hereby incorporated by reference herein and made a part of this specification.

### BACKGROUND OF THE INVENTION

1. Field of the Invention

The present invention relates to wireless communications, parking management, parking revenue control, real time electronic parking discount coupon for single space parking meters and parking lots.

2. Description of Related Art

Parking has always been a major problem for everyone involved, including the municipalities, parking operators, or drivers. As a number of vehicles on the roads steadily increases, availability of parking spaces is becoming very much of an issue.

The first parking meter appeared in Oklahoma City, Okla. on Jul. 16, 1935; following the request of local merchants who did not like the fact that the drivers were parking at their storefronts all day, hogging thus valuable real estate and making finding parking place difficult for other shoppers. Carl McGee was granted U.S. Pat. No. 2,118,318 a few years later and since then the parking meters business grew into US$3 billion industry. Many merchants today curse the parking meter as it “forces the shopper to pay for parking while the large retailers and shopping malls offer free parking”.

Many parking garages and lots offer parking validations programs that are easy to administer as participating merchants stamp the parking stub and the parking garage or lot attendant will adjust a final price when the vehicle is leaving the parking garage or lot. Providing parking validation for single-space parking meters is much more difficult, simply because there are no attendants at the parking meters and also payment for the parking meter must be rendered first. The topic of how to easily and conveniently provide parking validation for single-space parking meters, whether these meters are located in downtown, off-street parking lot, hospital, college, or airport, is a focus in the industry and also an long-term need.

One known way to attempt to validate parking meter parking is the use of the so-called “parking tokens” used in cities like Sioux Falls, S. Dak.; Salt Lake City, Utah; Fredericton, NB; Edmonton, AB; and many others. However, in the proposed validation method, the municipalities in the city must either modify existing parking meters or order new ones so that the single-space parking meter is capable of accepting these tokens. The municipalities must manufacture tokens and distribute them to interested merchants while guarding these tokens as if they were cash. A participating merchant or an entity must acquire these tokens from the municipalities and distribute them to the drivers, or the clients. Finally, drivers must hang on to the token as they can only use it at their next parking event; there is no way for these tokens to be used to pay for the current parking session.

Not only is this process fairly complicated, it is also quite expensive from the capital expenditures perspective that the meters must be modified to accept specific tokens and these tokens must then be manufactured; it is also quite expensive to operate, as evidenced by the 2004 Annual report of the Downtown Edmonton Business Association, where the cost of the management of the “Downtown Dollar” program was C$90,922 in 2004, while their total annual budget for 2004 was C$1,071,803.

### SUMMARY OF THE INVENTION

Accordingly, the present invention is directed to a method and a system for electronic parking validation using a pay by cell parking system for allowing any entity to offer instant parking credit covering a portion or the whole amount of parking charges. The credit is directly applicable to the current parking charges. The system of the present invention has an operational pay-by-cell parking system in place and the recipient of the parking credit is a registered customer in good standing of the system.

According to an embodiment of the present invention, the system comprises a suite of computer programs residing on a server for remote wireless parking management and payment. The suite of computer programs verifies a third party payment request, such as a third party using a wireless or landline telephone to request access. The programs grants or rejects such access request based on a plurality of authentication rules defined within the server resident program suite. The authentication rules, in one embodiment, may be modified in real time, and may include real time communication of the payment status to the parking control officer (PCO).

According to an embodiment of the present invention, the suite of computer programs residing on the server provides a parking voucher to the holder to claim for the free parking assuming the holder of the said voucher is a registered user of a pay-by-cell system.

According to an embodiment of the present invention, the suite of computer programs residing on the server allows an issuing merchant to set up conditions to the parking voucher, such as consent to accept real time targeted advertisements when the recipient of the voucher parks again in the vicinity of the merchant issuing a coupon.

According to an embodiment of the present invention, the suite of computer programs residing on the server provides a flexible parking validation at single space parking meters or parking lots using pay by cell system that can be tailored according to the needs of the parking operator or nearby merchant or institution.

According to an embodiment of the present invention, the suite of computer programs residing on the server is capable of recording all of the transactional information for providing convenience to the user for various purposes, for example income tax, and all events of such subsidized or free parking and itemized receipts of parking charges and parking discounts.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an embodiment of a parking voucher of the present invention.

FIG. 2 is a preferred embodiment of a back end parking server resident software application of the invention.

FIG. 3 is a flow chart showing an overall system schematics and detailed interactions of a preferred embodiment of the invention.

### DESCRIPTION OF EMBODIMENTS

The method and system to provide electronic parking validation for drivers using a pay by cell parking system proposed in the present invention allow any entity to offer instant parking credit covering a portion or the whole amount of parking charges, this credit being directly applicable to the current parking charges. The entity can be, such as in a way of example but not limited thereto, a store, a professional office, or a restaurant, which are located in a vicinity of the paid parking space, whether on-street or off-street. The required condition is that there is an operational pay-by-cell parking system in place and the recipient of the parking credit is a registered customer in good standing of such a system.

The method and system to provide electronic parking validation for the drivers using a pay by cell parking system in the invention is able to generate parking revenues for the municipal government or parking operator; and yet offer availability of free or discounted parking to the visitors of the establishments nearby the parking space. In addition, the method and system of the invention is able to do so without any capital expenditure or ongoing hardware maintenance. The method and system of the invention is also able to provide itemized parking receipts for income tax or similar purposes.

It is thus clear that the invention provides real time, electronic, parking validation for single space parking meters. The invention does not require any changes to the parking meter. The invention can be applied against current parking, and fill in the void that exists when it comes to the parking validation process for drivers that park at any of the estimated 5 million parking meters in USA and Canada.

Moreover, it can also alleviate local political tensions between a downtown business association and City Hall, which can be significant as evidenced by the recent project conducted by the City of Lethbridge, Alberta in 2005, the results of which were presented at the 2005 Canadian Parking Association in Niagara Falls, ONT. City of Lethbridge countered the complaints of merchants that were claiming that parking meters were driving shoppers away to the shopping malls and decided to offer 2 hour parking in downtown and monitored the impact on the downtown businesses. The preliminary results showed little variance in parking volume but the city lost about C$60,000 during this study.

The present invention is ideally suited to eliminate these frictions as when a program to provide electronic parking validation for drivers using the pay by cell parking system is fully deployed, merchants can absorb the cost of the current parking transactions of their customers while City will get its parking revenues. The system must be used in conjunction with a pay-by-cell system, already in operation in, for example Saskatoon, SK.

Participating merchants will hand out parking coupons, each coupon having a unique ID number to their customers. The customer may or may not redeem the coupon. What is important is that the merchant is only charged when a particular coupon is redeemed by a customer. When the customer chooses not to redeem the coupon, there is no charge to the merchant.

The same system can be also deployed in parking lots which offer pay by cell system, the mechanism of parking payment and parking validation is identical. The only exception here is that some parking lots may already offer different way of parking validation that is described above.

In the following detailed description of the invention, reference is made to the drawings, which form a part of this application, and in which is shown by way of example in which the invention may be practiced. The details of the invention are described in sufficient detail to allow those sufficiently educated to utilize this invention. The following detailed description of our invention is hence not supposed to be taken in a limiting sense, and the scope of the present invention is defined only by our claims.

The detailed description is divided into three sections. In the first section, a parking voucher is described. In the second section, backend server-based software is described, especially from the viewpoint of its interaction with a driver and a participating merchant or other entity that wishes to provide subsidized or free parking to its visitors or employees. In the third section, a system level overview of the invention is presented. The third section describes an overall data flow, driver and/or enforcement officer interaction, and various conclusions derived from the overall system description are provided.

First Section—The Parking Voucher

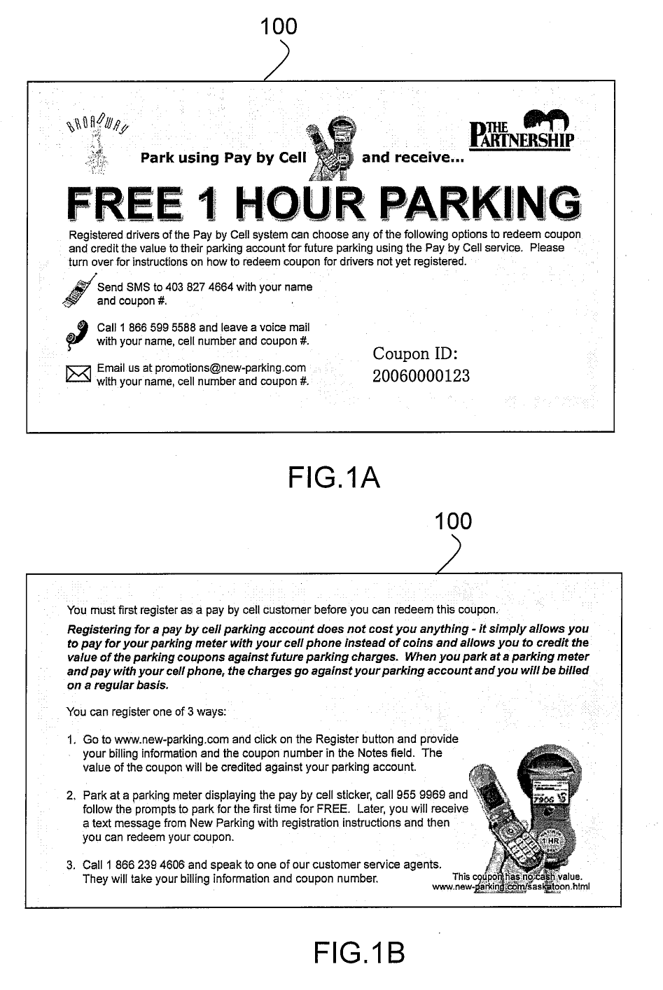

A parking voucher enables the holder to claim free parking. It is assumed that the holder of the voucher is a registered user of a pay-by-cell system. The voucher may contain following alternative information fields, but not limited thereto, a face value (parking time or dollar value) when redeemed, an unique ID, total amount of parking time desired, instructions on how to redeem this coupon, additional information about the pay by cell system and program to offer discounted or free parking in the given area. There may be several other information fields added to the voucher, but in essence it is a pre-paid parking coupon. An example of such a parking voucher is shown in FIGS. 1A and 1B. The parking voucher 100 has a plurality of information fields, including the face value (free one hour parking) when redeemed, the unique ID (coupon ID: 2006000123), the instructions on how to redeem this coupon, and information on how to register as a pay by cell customer.

Second Section—Back-End Parking Server Resident Software

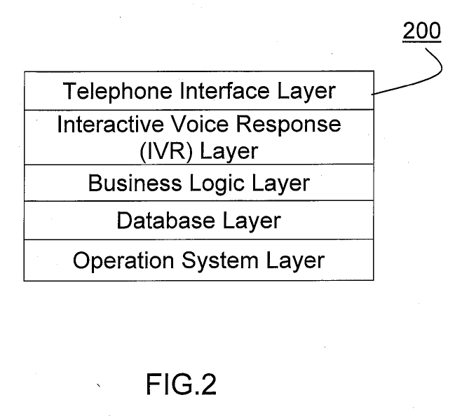

A back-end software application may be fully hosted and may be accessible by anyone who can access the Internet or a cell phone and has user account and password set up. FIG. 2 shows a preferred embodiment of the back-end parking server resident software application 200 including a plurality of layers for providing parking validation using a pay by cell parking system of the invention. More specifically, the back-end parking server resident software application includes a telephone interface layer, an interactive voice response (IVR) layer, a business logic layer, a database layer and an operation system. Each of these layers has its own specific function and communication interface to its adjacent layers. Following is a description of functionality of each of the layers according to an embodiment of the present invention.

Telephone Interface Layer

The telephone interface layer is implemented by both hardware and software layer, as it requires physical telephone switch capable of accepting larger number of parallel calls. Such a setup is commonly provided by any telephone system of telephone companies such as Verizon, SBC, and many others. One of the possible implementation is a continent wide toll-free number with a capacity to handle multiple concurrent telephone calls; or access can be set up as a local number per each real estate board, these local numbers then being forwarded to the telephone switch.

One function of the telephone interface layer is to capture the caller ID (ANI). The caller ID or the ANI (Automatic Number Identification) is provided by a service of most telephone companies, which indicates the number and name of an incoming call. One further function of the telephone interface layer is to capture an area code from which the call originates, and/or to capture the number which is being dialed (if applicable), and/or to capture information entered by the user from the keypad as per system prompts. The telephone interface layer passes on the captured information to the IVR layer.

IVR (Interactive Voice Response) Layer

The IVR layer is a software layer in which a call flow is being defined. The IVR layer can be a proprietary software environment such as VOS (Virtual Operating System) software; or open standard environment such as voice extensible markup language (VoiceXML). The function of the interactive voice response layer is to accept information from the telephone interface layer, pass them on to the business logic layer and play appropriate messages to the caller based on the response received from the business logic layer, and then again accept user's input from the telephone interface layer pass it on to the business logic layer; until such time when the call terminates.

In an example of coupon ID verification, in a situation when a driver calls the system of the present invention, the caller ID of the driver is captured and passed onto the business layer, which replies “Caller ID OK.” At the end of the parking session, the driver may wish to redeem the parking coupon just received by the driver. As such, when the driver calls the system to terminate the current parking transaction, the system will prompt whether a driver would like to redeem a parking coupon. In one embodiment, the method for verifying the coupon ID may be described as follows.

First, the driver enters the coupon ID on the keypad of a mobile phone. The telephone interface layer accepts the coupon ID and passes it onto the IVR layer, which in turn passes it onto business layer. The business layer will verify the coupon ID and reports back to the IVR layer whether the coupon ID was correct or incorrect. The IVR plays appropriate message based on the information received from the business logic layer, if the coupon ID was correct, then transaction continues; otherwise the process of requesting the coupon ID repeated one more time.

The messages generated by the IVR layer can be either pre-recorded voice files (such as *.wav file format) or generated by a so-called “Text To Speech” (TTS) technology, wherein the computer system itself synthesizes the voice.

The IVR layer is also responsible for “broadcasts”, i.e., wireless communication whose content may be transaction approval, notification of a friend parking nearby, lottery winnings etc.

Business Logic Layer

The business logic layer is the core of the embodiment of the present invention where the decisions are made based on the data received from the IVR layer and the data already contained in the database.

In the example above, the business layer may accept the coupon ID from the IVR layer, and may have already acknowledged the account information linked to the specific caller ID. The business layer compares the coupon ID entered from the keypad by the user and obtained from the IVR layer with the coupon ID already defined in the database. Based on the result of the logical transaction, the business logic layer then decides how to continue. For example, the business logic layer may request the driver to re-enter the coupon ID if this coupon ID entered from the keypad by the user differs from the allowed coupon IDs in the database, or authorize the transaction and follow on to the next step of crediting the parker's account with the value of the coupon, debiting account of the issuing party and also mark the coupon ID as “used” in the database so this particular coupon ID may not be used again.

According to an embodiment of the present invention, the business logic layer may be designed to keep all the transaction-relevant data in the operating memory, for example, random access memory (RAM), or may access the data from the next layer, the database layer. Both options are fully functional and both have their own advantages and disadvantages in terms of speed of access, execution, system stability, computing resource requirements etc.

According to another embodiment of the present invention, the whole process may be performed manually as follows. First, the user receives a parking coupon from a participating entity. If the user is a registered user of a pay-by-cell system, user can redeem it immediately; otherwise the user has to set up an account by calling a customer service or registering through the web. The user will then communicate the coupon ID, his or her name and cell phone number to the customer service of the pay by cell operator and the customer service representative will verify coupon ID and if correct, will credit the account of the user.

Database Layer

This is the layer where the data are actually stored and can be accessed from the business logic layer. The type of the relational database can be commercial ones like Informix™ or Oracle®, or open source ones such as MySQL and PosgreSQL. The function of the database layer is to store the data and furnish the data when requested by the business logic layer, or to add further data or modify existing data again as requested by business logic.

Operating System Layer

The operation system layer is the layer present by definition in all software applications, as the layer will enable the communication with the underlying hardware. Most common operating systems are provided either by Microsoft® Corp or different vendors of Unix® systems, or an open-source Linux operating systems. For the purpose of the invention, it is irrelevant which OS is being used.

Third Section—System Level Overview

In an embodiment, there are four potential main players in the system including: (1) a driver parking the vehicle; (2) a back end server resident software system; (3) a merchant or other entity issuing discounted parking coupons; and (4) customer service representative (optional).

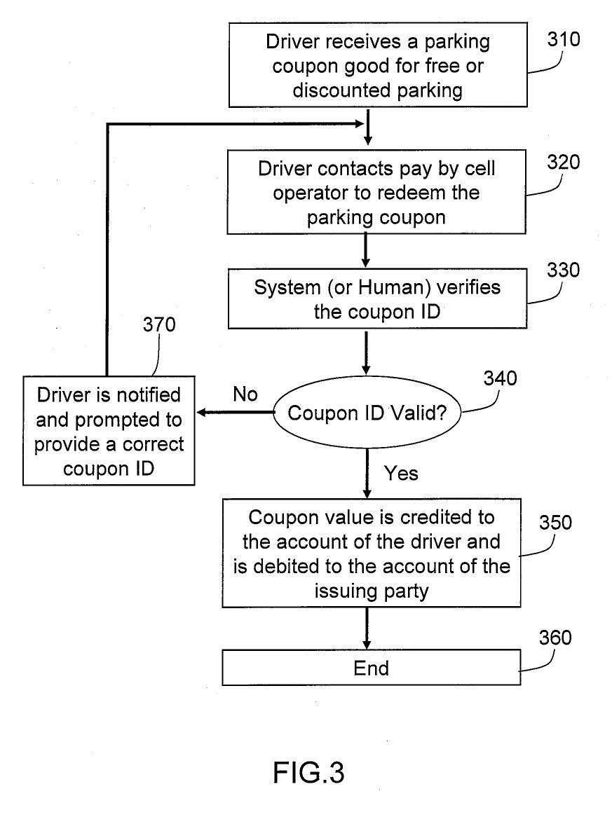

The interaction of the above players can be seen in the FIG. 3. The driver parks the vehicle in the paid for parking area whether at a single space parking meter or in a parking lot that offers a pay by cell option. The driver calls the system using his or her cell phone and parks. The driver visits an entity that offers discounted parking coupon, perhaps a store or a restaurant. After finishing the business (or lunch), store personnel will offer a coupon to the driver, as shown in step 310. The driver will either calls and enter the coupon ID when prompted by a system (in a fully automated version) or will send the coupon ID together with his or her name and a cell phone number to the customer service of the company that offers pay by cell, as in step 320.

As in step 330, the system or the customer service representative will verify the coupon ID and adjust the driver's account accordingly. The driver can communicate with the customer service department by the way of text message (SMS), call, email or other means designed to transfer the required information from the driver to the customer service department. When the coupon ID is validated, as in step 340, an account of the driver is credited and the account of the issuing vendor (the merchant or other entity issuing discounted parking coupons) is debited by the same amount and optionally by a service fee which may be levied by the company administering the system, as in step 350. However, if the coupon ID is not valid, as in step 370, the driver is notified and prompted to provide a correct coupon ID, and the driver has to send the coupon ID again to the customer service of the company that offers pay by cell, in which the process returns to step 320 again, or the process is terminated.

The invoice for the transaction above is issued in a regular interval (for example monthly) to both drivers and the merchants (or other issuing entities) so that every single parking transaction and every single coupon transaction is captured and sent to the respective parties.

The present invention provides a system for providing electronic parking validation using a pay by cell parking system, which allows any entity to offer instant parking credit covering a portion or the whole amount of parking charges. The credit is directly applicable to the current parking charges. The system in the invention has an operational pay-by-cell parking system in place and the recipient of the parking credit is a registered customer in good standing of the system.

According to an embodiment of the present invention, the system comprises a suite of computer programs residing on a server for remote wireless parking management and payment. The suite of computer programs verifies a third party payment request, such a third party using a wireless or landline telephone to request access. The suite of the computer programs grants or rejects such access request based on a plurality of authentication rules defined within the server resident program suite. The authentication rules, in one embodiment of the present invention, are modified in real time, and may include real time communication of the payment status to the parking control officer (PCO).

According to an embodiment of the preset invention, the suite of computer programs residing on the server provides a parking voucher to the driver for the free parking assuming the holder of the said voucher is a registered user of a pay-by-cell system.

The suite of computer programs residing on the server may allow the issuing merchant to set up conditions to the said parking voucher, such as consent to accept real time targeted advertisements when the recipient of the voucher parks again in the vicinity of the merchant issuing a coupon, as described in the US patent application, serial number is Ser. No. 10/877,756, filed Jun. 24, 2004, which is the same inventor of the application, and all disclosures of the prior application are incorporated herein by reference.

The suite of computer programs residing on the server above may provide flexible parking validation at single space parking meters or parking lots using pay by cell system that can be tailored according to the needs of the parking operator or nearby merchant or institution, such as for example validate parking for training sessions employee provided free or discounted parking.

The suite of computer programs residing on the server has a capability to record all of transactional information for providing convenience to the users for various purposes, for example for income tax, all events of such subsidized or free parking and provide itemized receipts of parking charges and parking discounts.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for remote parking management and payment, comprising:
verifying a payment request from a user;
granting or rejecting the payment request based on an authentication rule defined within an resident program suite, wherein said authentication rule is modified on real time basis; and
real time communicating a payment status for the parking management in response to granting the payment request based on the authentication rule.

2. The method of claim 1, wherein the payment request from the user is sent by wireless communication or landline telephone to request access.

3. The method of claim 1, wherein the user claims for free parking using a parking voucher if the user is a registered user of a pay-by-cell system.

4. The method of claim 3, wherein the parking voucher is issued by a merchant, wherein the merchant can set up conditions to the parking voucher, and if the user uses the parking voucher for the payment request, the user is consent to accept the preset conditions.

5. The method of claim 4, wherein one of the conditions includes a recipient of the parking voucher is consent to accept real time targeted advertisements when the recipient of the parking voucher parks again in a vicinity of the merchant.

6. The method of claim 1, wherein a flexible parking validation is provided for verifying of the payment request from the user at single space parking meters or parking lots using a pay by cell system that is tailored according to a parking operator or nearby merchant or institution.

7. The method of claim 1, wherein the resident program suite comprises an interactive voice response (IVR) layer and a business logic layer,
wherein the interactive voice response layer accepts the payment request from the user, passes the payment request on to the business logic layer and plays messages to the user based on an response received from the business logic layer, and accepts input from the user according to the response and passes the input on to the business logic layer until the user terminates the payment request,
wherein the business layer compares a coupon identification (ID) on a parking voucher from the user with a plurality of coupon IDs already defined in a database, the business logic layer outputs the response to the user through the interactive voice response layer according to the outcome of the logical transaction.

8. The method of claim 7, wherein if the coupon identification from the user in the payment request does not match any one of the plurality of the coupon IDs already defined in the database, the business logic layer outputs a request to the user to re-enter the coupon ID again.

9. The method of claim 7, wherein if the coupon identification from the user in the payment request matches any one of the plurality of the coupon IDs already defined in the database, the business logic layer authorizes the transaction and follows on to credit an account of the user with the value of the coupon on the parking voucher, debit an account of the merchant issuing the parking voucher and also marks the coupon ID as used in the database.

10. The method of claim 7, wherein the messages generated by the IVR layer is a pre-recorded voice file for playing voice corresponding to the response from the business layer to the user.

11. The method of claim 7, wherein the messages generated by the IVR layer is responsible for broadcasting for transaction approval, for notification of a friend parking nearby.

12. A system for remote parking management and payment, comprising:
a telephone interface layer, for capturing a caller ID of a call from a user and capturing an area code from which the call originates, and selectively capturing information entered by the user as per system prompts;
an interactive voice response layer, for accepting a payment request from the user, passes the payment request on to the business logic layer and plays messages to the user based on an response received from the business logic layer, and accepts input from the user according to the response and passes the input on to the business logic layer until the user terminates the payment request,
wherein the business layer compares a coupon identification (ID) on a parking voucher from the user with a plurality of coupon IDs already defined in a database, based on the outcome of the logical transaction, the business logic layer outputs the response to the user through the interactive voice response layer.

13. The system of claim 12, wherein if the coupon identification from the user in the payment request does not match any one of the plurality of the coupon IDs already defined in the database, the business logic layer outputs a request to the user to re-enter the coupon ID again.

14. The system of claim 12, wherein if the coupon identification from the user in the payment request matches any one of the plurality of the coupon IDs already defined in the database, the business logic layer authorizes the transaction and follows on to credit an account of the user with the value of the coupon on the parking voucher, debit an account of the merchant issuing the parking voucher and also marks the coupon ID as used in the database.

15. The system of claim 12, wherein the messages generated by the IVR layer is a pre-recorded voice file for playing voice corresponding to the response from the business layer to the user.

16. The system of claim 12, wherein the messages generated by the IVR layer is responsible for broadcasting for transaction approval, for notification of a friend parking nearby.
